(19) United States
(12) Patent Application Publication
(10) Pub. No.: US 2022/0303280 A1
(43) Pub. Date: Sep. 22, 2022

(54) MONITORING TRUST LEVELS OF NODES IN A COMPUTER NETWORK

(71) Applicant: Seagate Technology LLC, Fremont, CA (US)

(72) Inventor: Nicholas J. Dance, Boulder, CO (US)

(21) Appl. No.: 17/249,941

(22) Filed: Mar. 19, 2021

(51) Int. Cl. H04L 29/06

(52) U.S. Cl. CPC H04L 63/105; H04L 63/20; H04L 63/0435; H04L 63/0876

(57) ABSTRACT

Apparatus and method for the management of data transferred through a computer network by monitoring trust levels of intermediate nodes between a source node and a destination node. In some embodiments, trust levels are assigned to each of the nodes in the network. Data are transferred from the source node to the destination node along a selected data path. Trust levels of the intermediate nodes along the data path are monitored and reported to a user associated with the destination node. In some cases, nodes having unacceptable trust levels are avoided as part of the data path. In other cases, paths that include nodes with unacceptably low trust levels result in the received data being subjected to additional levels of verification.

### SUMMARY

Various embodiments of the present disclosure are generally directed to the management of data transferred through a computer network by monitoring trust levels of intermediate nodes between a source node and a receiving node.

In some embodiments, trust levels are assigned to each of the nodes in the network. Data are transferred from a source node to a destination node along a selected data path. Trust levels of the intermediate nodes along the data path are monitored and reported to a user associated with the destination node. In some cases, nodes having unacceptable trust levels are avoided as part of the data path. In other cases, paths that include nodes with unacceptably low trust levels result in the received data being subjected to additional levels of verification.

These and other features which characterize various embodiments of the present disclosure can be understood in view of the following detailed discussion and the accompanying drawings.

### BRIEF DESCRIPTION OF THE DRAWINGS

FIG. 1 is a functional block representation of a data processing system which operates in accordance with various embodiments of the present disclosure.

FIG. 2 shows a computer network that can incorporate host devices and storage devices as depicted in FIG. 1.

FIG. 3 illustrates different data paths through a network such as depicted in FIG. 2 through nodes having different trust levels.

FIG. 4 provides a functional block representation of a trust manager constructed and operated in accordance with various embodiments of the present disclosure.

FIG. 5 shows an exemplary format for a data packet that may be transferred through the networks of FIGS. 2-3 with trust information utilized by the trust manager of FIG. 4.

FIG. 6 shows the trust manager of FIG. 4 in greater detail in accordance with some embodiments.

FIG. 7 illustrates an encryption block that may be utilized by the trust manager of FIG. 4.

FIG. 8 illustrates a hash block that may be utilized by the trust manager of FIG. 4.

FIG. 9 shows another hash block that can be used by the trust manager of FIG. 4.

FIG. 10 is a timing sequence to illustrate a centralized authentication operation that can be utilized by the trust manager of FIG. 6.

FIG. 11 is a timing sequence to illustrate a decentralized, peer-to-peer authentication operation that can be utilized by the trust manager of FIG. 6.

FIG. 12 shows another aspect of the circuitry of various embodiments.

FIG. 13 illustrates passage of a data set through a network in accordance with some embodiments.

FIG. 14 illustrates a system on chip (SOC) configuration that can be used in a data storage device of the system in accordance with some embodiments.

FIG. 15 is a trust management sequence illustrative of steps carried out in accordance with some embodiments.

FIG. 16 is a functional block representation of a storage node configured and operated in accordance with some embodiments.

FIG. 17 is a storage enclosure of FIG. 16.

FIG. 18 is another functional block representation of some embodiments.

### DETAILED DESCRIPTION

Various embodiments of the present disclosure are generally directed to establishing and tracking trust levels for various nodes in a computer network as data sets are transferred through the network from a source node to a destination node.

Data security schemes are used to protect data in a computer system against access and tampering by an unauthorized third party. Data security schemes can employ a variety of cryptographic security techniques, such as data encryption and other data security protocols.

Data encryption generally involves the transformation of an input data sequence into an encrypted output data sequence using a selected encryption algorithm. The input data can be referred to as plaintext, the output data can he referred to as ciphertext, and the selected encryption algorithm can be referred to as a. cipher. The cipher may utilize one or more pieces of auxiliary data (keys) to effect the transformation. In this context, plaintext can include data that have been previously encrypted by an upstream encryption process, so encrypted ciphertext can be plaintext for a downstream encryption process.

Data security protocols generally deal with maintaining the security of data within a system, such as by establishing symmetric keys, carrying out secret sharing transactions, establishing and verifying connections, authenticating data, generating digital signatures and keyed message digests, establishing block chain ledgers, issuing challenge values for an authentication process, etc. In some cases, UMACs (hashed message authentication codes) can be generated and transmitted along with a data payload to help ensure that the received data payload from a secure source has not been altered or corrupted in transit.

These and other data security schemes are implemented around a concept often referred to as trust. Generally speaking, trust is a signifier that indicates the extent to which a particular data set can be either accepted for further processing or rejected and discarded. The trust level is a measure of the trustworthiness, or confidence, that can be placed in the data. A trusted relationship exists between nodes if there is sufficient. evidence that communications among the nodes are reliable and trustworthy. As in human relationships, nodal relationships can operate with various levels of trust, including absolute trust, high trust, medium trust, low trust and completely trust-free environments. Unfortunately, as is with human relationships, nodal relationships can have nodes that exhibit trustworthy operation but can in time turn out to be untrustworthy (and vice versa).

There are a number of ways to establish trust among nodes. One commonly employed approach involves data exchanges that are carried out to verify authentic nodes. This can include the transfer of challenge values, hashes, secret information, timing values and other data that enable two communicating nodes to authenticate one another with an acceptable level of trust. In some cases, secret information, such as a private encryption key known only to trusted nodes, can be used as part of the verification process.

A group of authenticated nodes (devices) can be viewed as existing within a “trust boundary” so that all of the devices within the designated trust boundary are confirmed as being sufficiently trustworthy. This boundary can be established using security protocols that establish that all of the known elements within this boundary are trustworthy. Nevertheless, even in a trusted environment, data transfers between nodes are often encoded by, or appended with, additional security information to further enhance trust levels within the system. This provides an on-going assessment of trustworthiness of the system.

While operable, the continued reliance upon computer networks provides an ongoing need for advancements in evaluating and ensuring the trustworthiness of data communications among various nodes involved in data transfers. It is to these and other advancements that various embodiments are generally directed.

The present disclosure provides systems and methods for evaluating trust along a data path through a computer network. As explained below, some embodiments include a mechanism which assigns a trust level to each of a plurality of nodes in the network. Data are transferred through the network from a source node to a destination (end user) node along one or more selected data paths that involve one or more intermediate nodes. The trust levels of the various source, intermediate and destination nodes are accumulated and provided to an end user of the destination node in the form of a notification report. Various actions may be taken as a result of these reported trust levels of the nodes involved in the data transfer.

In some cases, a minimum specified trust threshold is required, so that nodes with trust levels below this threshold are avoided and do not form a part of the data path. In other cases, additional verification operations may take place as a result of the respective trust levels indicated along the transmission path. For example, if data are passed through a node with an unacceptably low trust level, additional steps are taken to validate the received data to compensate for the fact that an untrustworthy node was involved in the data transfer.

In still other cases, history data are accumulated to monitor various paths taken through the system, and these history data are used to take various corrective actions to expedite future data transfers with improved trust characteristics. A number of other alternatives are also contemplated and will be discussed below.

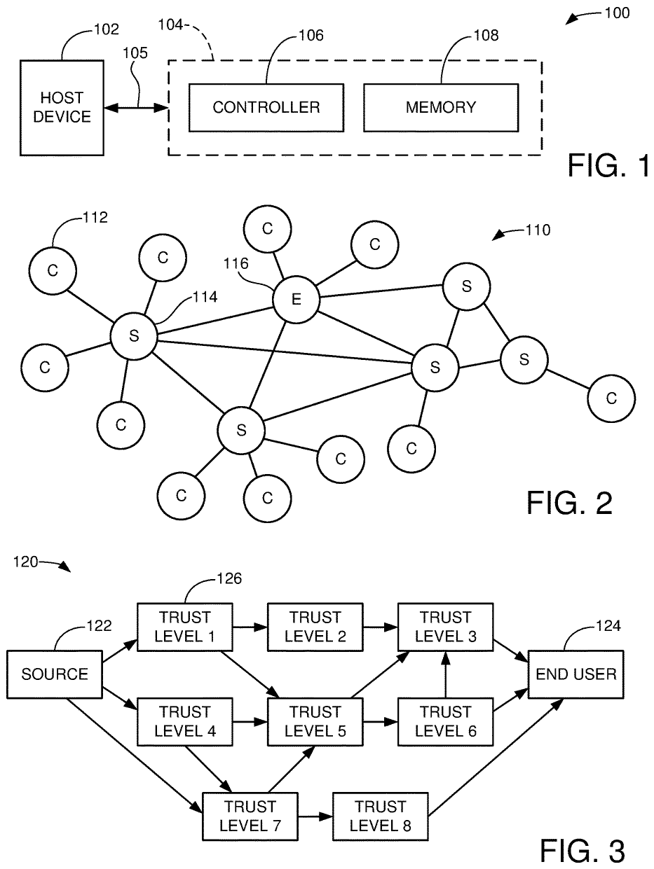

These and other features and advantages of various embodiments can be understood beginning with a review of FIG. 1 which shows a data processing system 100. The data processing system 100 includes a host (client) device 102 operably coupled to a data storage device 104 via a suitable interface 105.

The host device 102 and the data storage device 104 can each take a variety of forms. Without limitation, the host device 102 may take the form of a programmable processor, a personal computer, a workstation, a server, a laptop computer, a portable handheld device, a smart phone, a tablet, a gaming console, a RAID controller, a storage controller, a scheduler, a data center controller, etc. The data storage device 104 may be a hard disc drive (HDD), a solid-state drive (SSD), a thumb drive, an optical drive, a tape drive, an integrated memory module, a multi-device storage array, a network attached storage (NAS) system, a data center, etc. The interface 105 can be a :local wired or wireless connection, a network, a distributed communication system (e.g., the Internet), a network that involves a satellite constellation, etc. The interface 105 can also be various combinations of these and other forms of interconnections.

The data storage device 104 may be incorporated into the client device 102 or may be arranged as an external component. For purposes of the present discussion, it will be contemplated that the host device 102 is a computer and the data storage device 104 provides a main memory store for user data generated by the host device. While not limiting, the memory 108 may include non-volatile memory (NVM) to provide persistent storage of data. As will be recognized by the skilled artisan, an NVM maintains data stored thereto even in the absence of applied power to the NVM for an extended period of time.

FIG. 2 shows a computer network 110 in a distributed data storage environment. The network 110 has a number of interconnected processing nodes including client (C) nodes 112 and server (S) nodes 114. The client nodes 112 may represent local user systems with host computers 102 and one or more storage devices 104 as depicted in FIG. 1. The server nodes 114 may interconnect groups of remotely connected clients and may include various processing and storage resources (e.g., servers, storage arrays, etc.) and likewise incorporate mechanisms such as the host device 102 and storage device 104 in FIG. 1. Other arrangements can be used. It will be understood that the monitoring processing described herein can be used to track the operation of the server nodes 114 responsive to requests issued by the client nodes 112.

Generally,any node in the system can communicate directly or indirectly with any other node. The network 110 can be a private network, a public network, a high performance computing (HPC) network, a cloud computing environment, a software container system, the Internet, a :local area network (LAN), a wide area network (WAN), a satellite constellation, an Internet of Things (IoT) arrangement, a. microcontroller environment, or any combination of these or other network configurations. Local collections of devices can be coupled to edge computing devices that provide edge of Internet processing for larger processing-based networks. One such edge (E) device is denoted at 116.

FIG. 3 shows a data processing system 120 that may form a portion of a computer network such as represented at 110 in FIG. 2. Generally,the system 120 in FIG. 3 operates to transfer data from a source node 122 (hereinafter “source”) to a destination node 124 (hereinafter “end user node” or “end user”). One or more intermediate nodes 126 are involved in this data exchange between the source 122 and the end user 124.

The form and type of data transfer between the source 122 and the end user 124 is not germane to the present discussion, as substantially any sort of network communication can be used to transmit at least one bit from the source to the end user. As such, the data transfer may be the issuance of a simple command, the transfer of data from the source 122 to the end user 124 for storage at the end user node, a request to retrieve data stored at the end user, the initiation of the execution of a selected application, the launching and execution of a software container, a query of a data base, a status query, a trim command, and so on.

In some cases, requests issued by the source 122 result in a return path response that is subsequently forwarded from the end user 124 back to the source to complete the transaction. These requests and responses may take different paths through the network and can be viewed as separate, albeit related, transactions. For example, a first transaction may involve an initiator node (such as the source 122) directing a request to a target node (such as the end user 124), and a second transaction may subsequently involve the target node passing data back to the initiator node in response to the request. In this type of exchange, the initiator node may be the “source” node for the first transaction and the target node may be the “source node” for the second, follow-up transaction. The respective data paths taken between these nodes may be analyzed and processed separately or together in accordance with various embodiments.

In order to transfer these and other forms of data, one or more paths through the system 120 may be used. As used herein, a “path” is an indication of at least all intermediate devices (nodes) that were involved in the associated data transfer. The path can also include the source node and the destination node in at least some cases. A total of eight (8) intermediate nodes 126 are depicted in FIG. 3, although it will be understood that any number of available nodes may be present in a given system. Each of the intermediate nodes 126 may be configured with routing, controller, monitoring and local data storage functions to enable data, usually in the form of packets, to be received, evaluated and forwarded in order to direct the packets to the destination node 124. To this end, each node 126 may have a configuration as generally depicted in FIG. 1, including a local host device 102 and a local storage device 104, although such is not necessarily required.

Each of the intermediate nodes 126 in FIG. 3 has an arbitrarily assigned trust level denoted as Trust Level 1 to Trust Level 8. Specifics regarding trust levels will be provided in greater detail below, but at this point it will he understood that the various trust levels (TLs) are general indications of the reliability, or trustworthiness, of each of the nodes. Trust can be measured and expressed in a number of ways, such as on a sliding scale, In the present example, the Trust Levels 1-8 are arbitrary levels so that some of these respective nodes have a relatively higher level of trustworthiness and others of these nodes have a relatively lower level of trustworthiness.

It can be seen from FIG. 3 that there are numerous paths that can be taken by the data transferred from the source 122 to the end user 124. A first path may involve successively utilizing those nodes identified as having Trust Levels 1, 2 and 3. For convenience, this path is denoted as (TL1, TL2, TL3). Stated another way, this data path involves passing the data from source 122 to the node having Trust Level (TL) 1; from there to node TL2; from there to node TL1; and from there to the end user node 124. Other possible paths can include (TL4, TL5, TL6); (TL7, TL8); (TL7, TL5, TL6); (TL1, TL5, TL6, TL3); and so on.

Depending on the configuration of the system, a large block of data to be transferred from the source 122 to the end user 124 may be broken up into smaller packets of fixed size, and these respective packets may be transferred via different paths through the nodes 126. Indeed, this is one of the advantages of distributed data communication networks (e.g., the. Internet, etc.), since redundancies and other mechanisms can be incorporated in the data transfer arrangement to ensure reliable receipt of the data by the end user node 124 from the source 122 through different intermediary nodes 126.

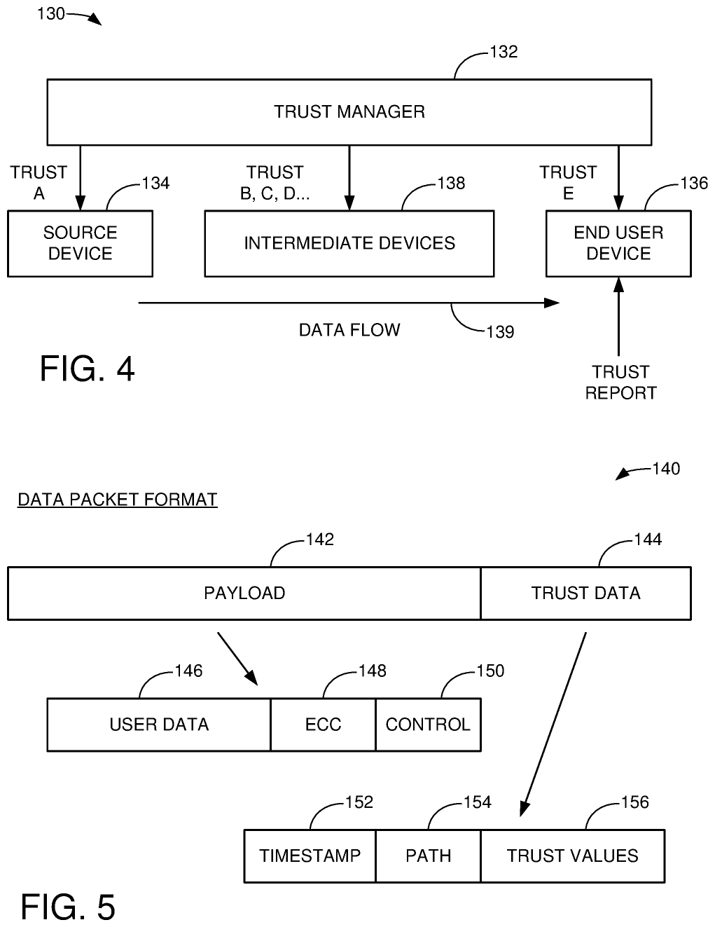

FIG. 4 illustrates a data management system 130 operable in accordance with various embodiments to manage the data transfers contemplated in FIG. 3. The data management system 130 includes a trust manager 132, The trust manager 132 operates, as explained below, to monitor and direct the data flows through the network. This may include data exchanges with various elements including a source device 134 (generally corresponding to the source node 122 in FIG. 3), an end user' device 136 (generally corresponding to the end user node 124), and various intermediate devices 138 (corresponding to the various intermediate nodes 126).

Various trust levels including A, B, C, D, E . . . , are established, monitored and used as data flows are provided from the source device 134 to the end user device 136, as indicated by data flow arrow 139. In some cases, the trust levels A and E of the respective source and end user devices 134, 136 may be taken into account by the operation of the trust manager 132.

FIG. 5 provides an exemplary format for a data packet 140 that may be forwarded through the systems of FIGS. 2-4. The format is merely for purposes of providing a concrete illustration and is not limiting, so other formats can be used as desired. It is contemplated albeit not required that the respective packets 140 will have a predetermined fixed size measured in any suitable quantity of bytes or other metrics. However, irregularly sized packets are contemplated and can be used depending on the requirements of a given application. Moreover, while it is contemplated that the format of FIG. 5 provides a specially configured packet, it will be understood that existing packet formats of the type utilized in current. generation transfers can be utilized with embedded or separately provided information that carry out the purposes of the present disclosure.

Should a given source (e.g., source device 134 in FIG. 4) send a large quantity of data (“data set”) to a selected end user device (e.g., 136), such as but not limited to a data file, an object, a software container, etc., the size of the overall data set is arbitrary and can be of substantially any size, and this data set may be broken down into some corresponding number of data packets in order to facilitate the data set transfer.

Each packet 140 accordingly includes a payload 142. and a set of trust data 144. The payload 142 can take any number of forms, but generally corresponds to the content of the data set (or that portion thereof incorporated into the packet).

The payload 142 can include a quantity of user data bits 146, error correction code (ECC) data 148, and control data 150. The user data bits represent the actual underlying data useful for the associated data set. The ECC can take any number of forms, including multiple layers of forms, such as but not limited to Reed Solomon codes, LDDC; (low density parity codes), RAID parity values, BCH (Bose—Chaudhuri—Hocquenghem) codes, etc. The control data 150 can provide information of substantially any type as desired including time/date stamp values, revision data, source data, etc.

The trust data 144 are appended to the payload data 142. and provide additional information of use by the trust manager 132 in FIG. 4. Without limitation, the trust data 144 can include time/date stamp data 152, path data 154, and individual trust values 156. Other types of control data can be used as required. The time/date stamp data 152 can be associated with the times at which various trust verification operations have taken place, and/or times at which data packets pass through various nodes. The path data 154 generally indicates which nodes are involved in a given data packet transfer. The trust values 156 generally indicate the trust values or other information associated with the respective nodes identified in the path data 154.

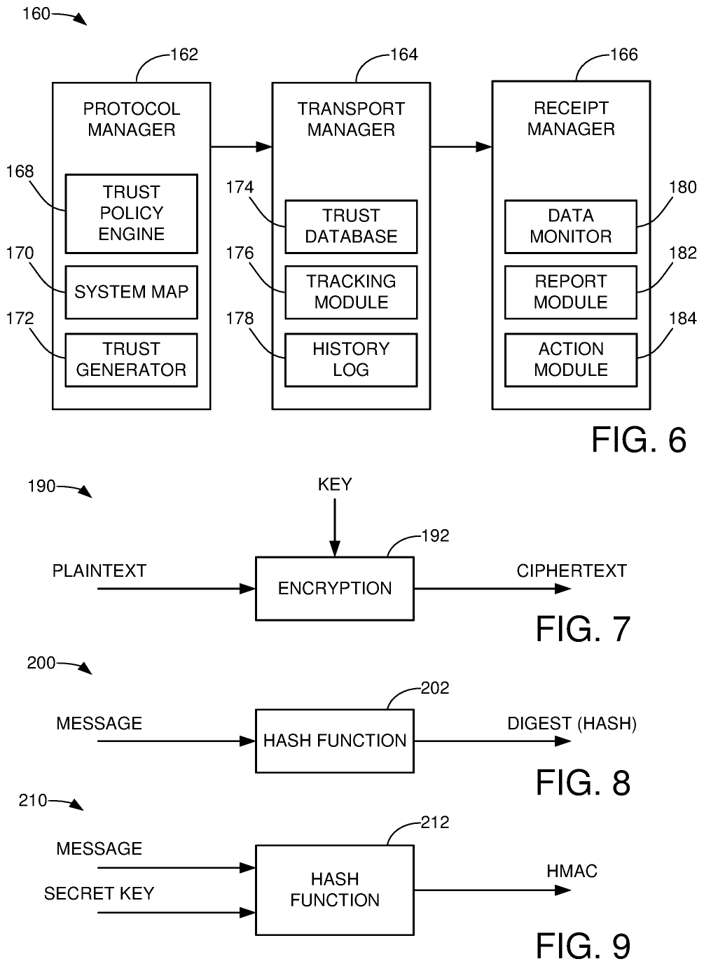

FIG. 6 provides a functional block representation of a trust manager 160 in accordance with some embodiments. The trust manager 160 can correspond to the trust manager 132 discussed above in FIG. 4. Other arrangements can be used. The trust manager 160 can be implemented using firmware, software and/or hardware. In some embodiments, aspects of the trust manager 160 are implemented as a software layer in a file management system of the network (such as Lustre®, etc.). In other embodiments, the trust manager 160 may be realized as programming utilized by one or more processors at a designated control (server) node within the system, along with other management functions (e.g., request schedulers, etc.). In still other arrangements, the trust manager 160 may be implemented as part of a background routine at the source and/or end user nodes. In yet other arrangements, the trust manager 160 may be implemented using gate logic in a hardware circuit.

The trust manager 160 is shown to include various sub-circuits, including a protocol manager 162, a transport, manager 164 and a receipt manager 166. The protocol manager 162 operates as a front end to perform various front end operations prior to the transfer of data sets. This can include operations to establish various trust protocols via trust policy engine 168, maintain a system map 170, and generate or otherwise establish trust levels through the system via trust generator 172.

The trust protocols from engine 168 can be established internally or externally. As noted above, the engine 168 can be realized using hardware or firmware/software, so that the engine 168 can be implemented as a hardware circuit utilizing an array of gate circuits, or can be arranged as programming stored in a local memory that is executed by one or more programmable processors (CPUs). In some cases, the trust policy engine 168 is a software layer in a larger software OS system. Those skilled in the art would be readily able to implement the trust policy engine 168 in any number of operable systems. The foregoing description of hardware and software implementations applies equally to other aspects of the system.

Regardless of form, it will be understood that the engine 168 utilizes various internal and external inputs to arrive at metrics and control limits under which the system is to be governed. In some cases, user (customer/client) specifications can be utilized, so that specific quality of service (QoS) and other system specifications are established for use of the system. Substantially any level of security scheme can be implemented by the engine 168. Different security schemes can be utilized for different clients, different end users, different levels of data sets, etc.

The trust levels managed by the engine 168 can be established and expressed in any number of ways. For purposes of the present discussion, a sliding scale can be used so that, for example, a minimum level such as a Trust Level (TL) of 0 can be used to identify a completely trust-free node in which no trust is reposited, and a maximum level such as TL of 100 can be used to identify a completely trusted node in which full trust is reposited. Depending on the verification processes, history data and other factors, trust levels can be assigned anywhere from 0 to 100 for the various nodes. It will be appreciated that other metrics can be used; for example, a trust level of A can designate a first trust level, a trust level of B can be used to designate a lower, second trust level, and so on.

It follows that the protocols used by the engine 168 can require at least a minimum level of trust be established for the various data paths. A minimum threshold T of a selected trust level TL can be any suitable value, such as a value of T=50 on the scale from TL=0 to TL=100, etc. In this case, the system can be configured in some embodiments such that the data packets (e.g., 140, FIG. 5) do not flow through any node having a level of trust below this specified minimum threshold (e.g., T <50); nodes with lower values are simply avoided and the data packets are rerouted to other nodes with higher, acceptable trust levels. As noted above, any, selected value of threshold T can be used, including but not limited to T values of 20, 25, 30, 35, 40, 45, 50, 55, 60, 65, 70, 75, 80, and so on. Other values can be used including values within or beyond these respective levels. Gradient levels of trust can also be used; for example, a node with a trust level of 48 might be treated differently, and subjected to less strict analysis than a node with a trust level of 19, etc.

Referring again to the example in FIG. 3, assuming that node TL4 has a trust level TL less than the specified T value, this node might be avoided during transfers from the source 122 to the end user 124. In this case, data transfers initiated by source node 122 would need to pass either to node TL1 or node TL7, and then on from there to the destination node 124.

In further cases, data packets are allowed to flow through nodes haying trust levels below the specified minimum threshold. In this case, these data packets are subjected to additional verification operations at the back end to ensure trustworthiness. Using the previous example, data packets passing through node TL4 in FIG. 3 may be subjected to additional levels of processing that are not applied to data packets that avoid this node (e.g., packets that pass from the source node to nodes TL1 or TL7 and hence, avoid node TL4).

Continuing with FIG. 6, the system map 170 maintains a map of the system, including the various interconnections among nodes as well as indications of the most recently established trust levels for the respective nodes. The trust generator 172. performs trust verification operations to establish up-to-date trust levels for the various nodes through which the data pass as indicated by the map 170.

The transport manager 164 in FIG. 6 operates during actual data transfers to direct and monitor actual data transfers between source and end user nodes. The transport manager 164 thus operates prior to, during and/or after the actual transfer of data through the system. To this end, the transport manager 164 includes a trust database 174 which provides a listing of the various trust levels of the nodes in the network between the source and end user nodes. A tracking module 176 operates to select and track paths for the data packets 140 through the system based on the trust levels from the database 174, as well as on other factors (e.g., QoS delivery specifications, network loading levels, etc.).

In some cases, the tracking module 176 can operate in conjunction with the trust policy engine 168 and the system map 170 to ensure that a particular path is taken through the network for a given data set.

A history log 176 accumulates data associated with the transfer of the packets through the system. This can be expressed as a data structure in a memory that provides various entries including data transfers, all of the nodes that were involved in such transfers, time/date stamp data associated with such transfers, trust levels associated with the nodes involved in the transfers, and so on.

The receipt manager 166 in FIG. 6 is a back end processor that manages the receipt of the data packets at the end user as the data packets flow through the network. To this end, the receipt manager 166 can include a data monitor 180 which monitors, receives and evaluates the data forwarded by the transport manager 164. Without limitation, this can include all of the trust data from database 174, all of the tracking data from tracking module 176, and all of the history data accumulated by history log 178.

A report module 182 of the receipt manager 166 operates to generate a report, such as at the conclusion of a successful transfer of a selected data set, which summarizes the accumulated data. This may include a simple indication that all of the nodes involved in the transfer had trust levels that met or exceeded specified levels. More complex reporting may include statistical representations of how many and which nodes were involved in the transfer, the respective trust levels, and so on.

An action module 184 of the receipt manager 166 operates as required to take further actions if needed, such as providing an indication to the end user of unsafe transport conditions, additional verifications, and so on. 1n some cases, the trust manager 160 operates automatically to evaluate, generate and store reporting data and other information about the operation of the system. In other cases, the trust manager 160 can provide real-time notifications to a user via a suitable user interface. These notifications can allow the user to decide on an appropriate course of action as a result of the trust path taken to deliver the received data. The user may provide certain inputs via the user interface that, result in further operations that take place as a result of the data transfer operation. In this latter case, should a path be taken that does not meet system requirements, the user can decide whether to request a retransmission of the data along a more reliable pathway, can request that further authentication operations be applied to the received data to verify the data, and so on.

Having now provided a top level overview of the operation of the system, further details regarding trust levels will now be provided. As noted above, the concept of trust is a conceptual metric indicative of data security levels of individual components of an overall system. To this end, a variety of cryptographic functions can be employed to evaluate trust levels for various nodes.

FIG. 7 is a functional block representation of an encryption system 190 useful in accordance with some embodiments. The encryption system includes one or more encryption blocks 192, each of which applies an encryption algorithm to input data, referred to as plaintext, to transform the input data into output data, referred to as ciphertext. One or more encryption keys are supplied as part of the encoding process. Depending on the form of the algorithm, other control inputs can be supplied as well such as seed values, counter values, etc. It will be appreciated that multiple stages of encryption can be applied to a given set of data, so that the plaintext in FIG. 7 can be encrypted ciphertext from an upstream process.

Encryption algorithms such as used by block 192 essentially provide an encoding function so as to transform the input plaintext to an encoded form. In this way, information can be transmitted safely and the underlying contents cannot be easily discovered without the use of massive amounts of computational power unless knowledge of the key(s) is provided. Many forms of encryption are known in the art, including but not limited to symmetric key and public-private key encryption systems. Encryption systems are often implemented in software using programming stored in a local memory executed by a programmable processor, but other encryption circuit configurations can be used as well including gate logic, ASICs (application specific integrated circuits), FPGAs (field programmable gate arrays), etc.

FIG. 8 is a functional block representation of a hashing system 200 useful in further embodiments. The system 200 includes at least one hash function block 202, which applies a selected hash function to an input data string (referred to as a “message”). As desired, additional inputs can be supplied as well, such as so-called “nonce” values (not shown). Nonce values are often random number strings, although such are not necessarily required.

A hash function is a mathematical algorithm that maps the input data of arbitrary size (e.g., the “message”) to an output value of fixed size (“hash,” “message digest,” etc). Hash functions are one-way functions so that it is practically infeasible to invert a hash output to recover the original message based on the output hash value. A number of hash functions are commonly employed in modern cryptographic systems, such as the so-called class of SHA (secure hash algorithm) functions including SHA-1, SHA-256, etc.

Because hash functions tend to be deterministic, are collision-resistant and can be easily calculated, hash values can be supplied along with a message to provide evidence that the data have not been tampered with since the time of transmission. This can be verified by recalculating a new hash value based on the received message and comparing the new hash value to the original hash value. Other cryptographic uses for hash values are well known in the art.

FIG. 9 shows another hashing system 210 similar to the system 200 in FIG. 8. The system 210 generates an output referred to as a hash-based message authentication code, or HMAC. The HMAC output value is the result of a hash function upon an input message and a secret encryption (hash) key. In this way, the message can be forwarded along with an HMAC value to a recipient, and the recipient can calculate a new HMAC value based on the message and the secret key. If the respective HMAC values match, it can be determined that the source of the message is an authorized party with access to the secret key, and that the received message is bit-for-bit identical to the original message for which the initial HMAC value was calculated.

Many data security schemes apply multiple levels of processing to transmitted data; for example, a set of plaintext may be encrypted in accordance with FIG. 7, and this encrypted data may he transferred as an encrypted message along with one or more hash values. Processing at the receiving end may include decryption of the encrypted data as well as recalculation of various hash values to ensure, with a high trust level, that the received data correspond to the data initially forwarded by the source node. Other mechanisms can be employed as well, such as digital signatures, encryption using public-private key pairs, etc.

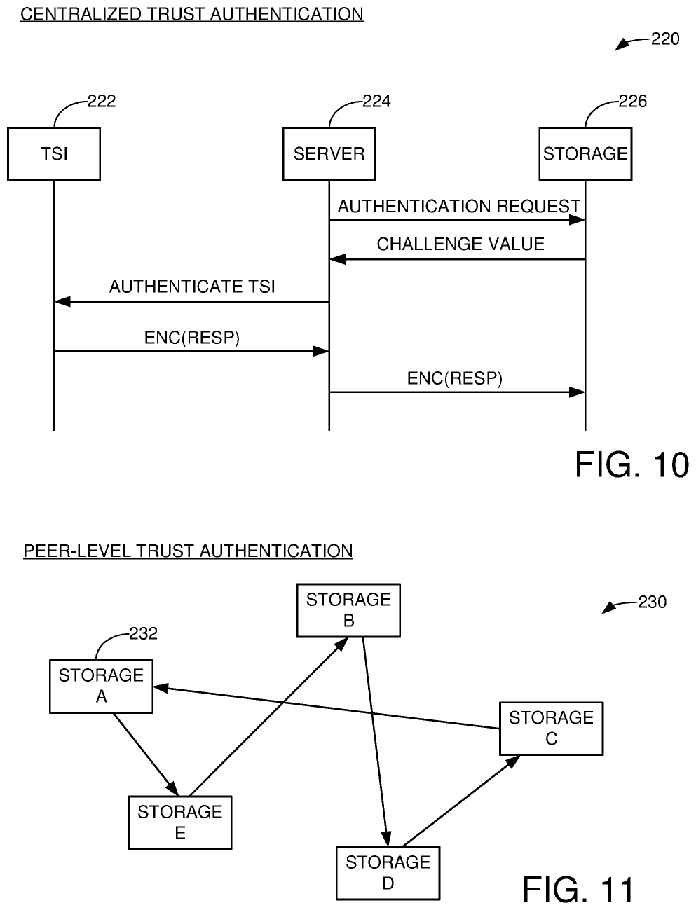

FIG. 10 shows a functional block diagram for a centralized authentication system 220 in accordance with some embodiments. The system 220 in FIG, 10 can be used to provide authentication of individual nodes, and/or devices within a particular node, to ensure a specified trust level. FIG. 10 includes a TSI (trusted security interface) node 222, a server node 224 and a storage node (device) 226. It will be appreciated that any number of respective devices can be involved in a centralized authorization sequence as depicted in FIG. 10, so the illustrated example is merely for purposes of illustration and is not limiting. Overall, the idea is that individual authentication exchanges take place among one (or more) serially connected devices in order to establish trust among these respective devices.

The sequence in FIG. 10 begins with the issuance of an authentication request from the server 224 to the storage node 226. This can take a number of forms and may be initiated in response to a previous signal (not shown) issued to the server. In response, the flow of FIG. 10 provides the generation and issuance of a challenge value back from the storage node 226 to the server 224. This may be a random sequence or some other value.

In response, the server 226 may provide encryption or other cryptographic processing to issue an authenticate TSI value to the TSI node 222. This authentication value may include some encoded form of the challenge value from the storage node 226. In response, an encrypted response, denoted as ENC(RESP), is forwarded back to the server 224. This response is processed as required by the server, and forwarded to the storage node 226.

This simple example illustrates how that individual devices can authenticate one another as part of a verification process. The various authentication data. exchanges can be attended by encryption operations using secret encryption keys, hash values, HVAC values, private-public key encryption techniques, etc. in order to ensure that the various devices are authenticated. The storage device might perform a hash function operation upon certain data or encrypt certain data using a secret key. If the responses received back from the other devices show evidence that these devices have access to the same secret key, provide responses that generate the same hash values, etc., a level of trust can be generated among these devices. For example, if the challenge value is a random sequence that is encrypted by the storage node 226 prior to transfer, and a subsequent response received back by the storage node includes an encrypted version of the random sequence that, once internally decrypted matches the originally issued challenge value, trust can be generated as a result. The resulting trust of the respective devices can be recorded and noted into the trust manager system 160 of FIG. 6, as described above.

Centralized authentication mechanisms such as depicted in FIG. 10 can be carried out continuously on a periodic basis to ensure that the respective devices with which a selected device communicates with are, in fact, authorized devices. As a result of the sequence shown in FIG. 10, it will be appreciated that successful authentication results in the server 224 having a high confidence in the trust levels for both the TSI and the storage node; the storage node 226 has a high confidence in the trust levels for both the TSI and server nodes 222, 224; and the TSI 222 can have a high confidence in both the server 224 and the storage node 226. As noted above, this type of centralized authentication can involve any number and levels of devices.

FIG. 11 shows a functional block diagram for a decentralized, or peer-level, authentication system 230 in accordance with further embodiments. As before, the system 230 in FIG. 11 can be used to provide authentication of individual nodes, and/or devices within a particular node, to ensure a specified trust level.

Unlike the centralized approach in FIG. 10, the decentralized approach 230 in FIG. 11 relies on individual storage nodes 232 communicating among one another to establish trust. Five (5) storage nodes 232 are identified in FIG. 11, noted as Storage A-E. In this particular arrangement, Storage Node (SN) C provides information to SN A in order to verify the veracity of SN C. SN A in turn provides information to SN E, SN E provides information to SN B, and so on back to SN C. In some cases, the information supplied may include secret information maintained by other nodes, which are verified in each subsequent transfer.

A number of peer-level authentication mechanisms have been proposed in the art, including peer-level operations that may involve a local hub (not separately shown in FIG. 11), round-robin approaches, multiple path verifications, etc. Regardless, the end result is essentially the same as depicted in FIG. 10; by the generation, transmission, receipt and evaluation of data received by other node(s), each node can both be authenticated as well as have a level of confidence (trust) in other nodes with which the node is in communication. These operations can be carried out repeatedly as required to maintain adequate levels of trust within the system.

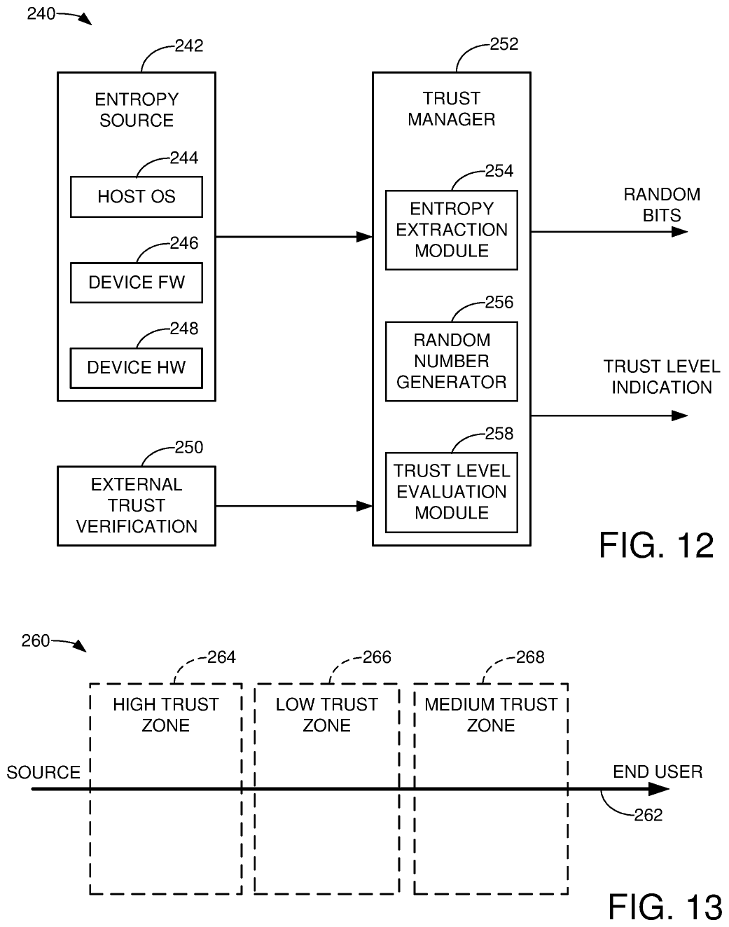

FIG. 12 shows another data processing system 240 in accordance with some embodiments. The system 240 can be readily incorporated into the systems and networks described above, and can be utilized to assess and maintain levels of trust among respective devices.

In FIG. 12, an entropy source 242 corresponds to a particular node i the system. For reference, the term “entropy” generally relates to the amount of information in a set of data. In one formulation, entropy is the minimum number of bits required to represent the data of interest. The entropy of a true random number string is the number of bits required to represent all possible values for the length of the string. Thus, ideally, the entropy of a true random number sequence is equal to its length; every bit in the sequence would be completely random and independent of every other bit in the sequence. Stated another way, the lower the entropy, the lower the security of a given set of data, since information stored within the string of bits can be more readily extracted as entropy is lowered.

Maximizing the amount of entropy in a random number used in a cryptographic function tends to maximize the effectiveness of the function against attack. For example, the greater the amount of entropy contained in a cryptographic key used to encrypt data using a selected cryptographic function (e.g., an encryption algorithm, an HMAC function, etc.), the greater the difficulty in guessing the key or determining the key using brute force methods.

The entropy source 242 in FIG. 12 provides a number of different subsystems that, can provide widely different levels of entropy in their respective outputs. Indeed, some of the sources can exhibit extremely low levels of entropy. Extraction techniques can be applied to extract random sequences with high levels of entropy from input values having relatively lower levels of entropy.

Trust has been discussed above, but now it can be understood that in at least some formulations, the term “trust level” can relate to the extent to which entropy in the output from an entropy source can be trusted. Trust level is based on a variety of factors. A storage device might treat the local entropy sources within its control as having a relatively high level of trust, since the entropy sources reside within the confines of its own system space (e.g.,“a local trust boundary”). A source outside this boundary, such as a host operating system (OS) entropy source that communicates with the storage device, might be treated as being less trustworthy.

Additional cryptographic trust boundaries may be formed within the storage device. For example, the storage device may view internal hardware based sources as more trustworthy as internal firmware based sources. This is based on the fact that new firmware can he loaded to the storage device, but the hardware characteristics of the device are dependent upon the actual hardware configuration of the device as manufactured. The greater the ability of external sources to influence a given bit string, the lower the entropy, and hence. the lower the trust. This is a truism that can be applied throughout any system.

It can be seen that entropy and trust levels are different, albeit related, concepts. A source that normally generates relatively high levels of entropy could be found to have a relatively low trust level, and a source that normally generates relatively low levels of entropy could be found to have a relatively high trust level. A number of statistical tests, certification protocols and hardening techniques are known in the art to evaluate both entropy and trust levels from a given source. Accordingly, it will be understood that the trust manager of FIG. 6 operates continually to establish trust levels for various nodes, monitor the trust levels at the times that data pass through such nodes, and accumulate these data at the back end to determine whether such transferred data are trustworthy and to implement such corrective actions as are required to address any issues raised thereby.

Referring again to FIG. 12, the entropy source 242 includes a host OS (operating system) entropy source 244, a device firmware (FW) entropy source 246 and a device hardware (FW) entropy source 248. These aspects relate to different electro-mechanical aspects of the system. Generally, the host OS source 244 may be located within a host device (such as 102 in FIG. 1) and can include programs, applications, OS subroutines, etc. that generate entropy values. One well known host OS level entropy source is the /dev/random function call (file) available in many UNIX® based operating systems. Execution of this function call returns a string of random numbers based on an accumulated pool of entropy values.

Some host OS level entropy sources can have a hardware component, such as specially configured circuits that generate statistically random noise signals based on various effects such as thermal noise, the photoelectric effect or other quantum phenomena, timing of certain events, the number of programming pulses required to program a flash memory cell to a particular value, etc. For example, a counter and timing system can be used to aggregate entropy values based on system events (e.g., keystrokes, system calls, etc.). The device FW entropy source 246 in FIG. 12 may be located in a data storage device (such as the storage device 104 in FIG. 1) and relates to entropy values generated by the storage device firmware. Examples include routines similar to the host OS level entropy sources such as timing circuits that aggregate entropy values based on system events, etc. Other sources of entropy at the FW level are readily available, such as timing indications at the times at which certain operations are carried out; the lowest bit indicators of bit values of various sensors obtained from system readings, and so on.

The device HW entropy sources 248 in FIG. 2 are also located in the data storage device and relate to entropy values obtained from the storage device hardware. Examples include but are not limited to ring oscillators and other specially configured random bit generator circuits designed to output entropy values; back electromagnetic force (BENIF) values obtained from voice coil current inputs used to position read/write actuators adjacent tracks on rotatable magnetic recording surfaces; the number of pulses required to achieve programming states of flash memory cells; and so on.

FIG. 12 further shows an external trust verification block 250. This block can provide additional trust and/or entropy inputs to the system as required, including values obtained from separate circuits. These circuits from block 250 can include, but are not limited, to, inputs supplied from other client devices, other storage device in the system, timing data associated with random inputs from external devices, and so on.

A trust manager is indicated at block 252. This trust manager generally corresponds to, but is not limited, to, the trust managers 132 and 160 discussed above. The trust manager 252 includes an entropy extraction module 254, a random number generator 256 and a trust level evaluation module 258.

The extraction module 254 takes the form of an entropy extractor adapted to extract entropy from one or more entropy sources, such as the sources 244, 246 and 248. Entropy extractors are known in the art, and will be understood to generally take low entropy inputs and manage these, through mathematical algorithms, to provide high entropy outputs, Statistical analyses can be applied to the outputs to further randomize, and hence increase the entropy of, the outputs of the system. By definition, the application of a hash function to a given input, such as described in FIGS. 8 and 9, tends to increase the entropy level of a given input. Other entropy extraction mechanisms are well known in the art and can be used as desired to further the operation of the various embodiments disclosed herein.

The trust manager 252 in FIG, 12 further includes a random number generator (RNG) 256. The RNG can operate to output one or more random numbers for use by the system in managing the security thereof. The random numbers generated by the RNG 256 can be generated in response to the entropy supplied by the various sources 244, 246, 248 and 250. The random numbers supplied by the RNG 256 can be true numbers, pseudo-random numbers, or random numbers that approximate true random numbers. These random numbers can be utilized by the system in a number of ways including in the generation of encryption keys, nonce values, challenge values, etc.

A trust level evaluation module is indicated at 258. This module operates to evaluate various trust levels of upstream nodes, such as during a data transfer operation. Outputs from the trust manager 252 in FIG. 12 includes a sequence of random bits, as well as trust level indications, which are managed as described above.

FIG. 13 illustrates a data flow system 260 to illustrate a data flow 262 through a network such as described above. The data flow 262 constitutes data flowing from a source node to a destination node. During the. flow, it is necessary that the data flow 262 passes among various nodes of the network. It is contemplated that during this flow, the data may pass through one or more high trust zones, as indicated at 264; one or more low trust zones, as indicated at 266; and one or more medium trust zones, as indicated at 268. These respective types of zones can be encountered throughout the data path, so that these groupings may not be physically based and are instead grouped on a trust basis.

From a physical standpoint, the data will flow from the source to the end user, most likely in a very highly efficient manner. However, from a trust standpoint, the flow will encounter nodes having potentially widely different trust levels, as indicated by FIG. 13.

As noted above, in some cases the most relevant aspects of the data flow 262 will be the extent to which data flowed through low trust zones 266, in which case corrective actions can be taken. However, per QoS specifications, routing decisions can be made such that the availability of nodes within high trust zones as indicated at 264 (and, to a lesser extent, the nodes in the medium trust zones 268) can be distributed so that, en toto, data transfers have at least an average available level of trust during the associated transfers.

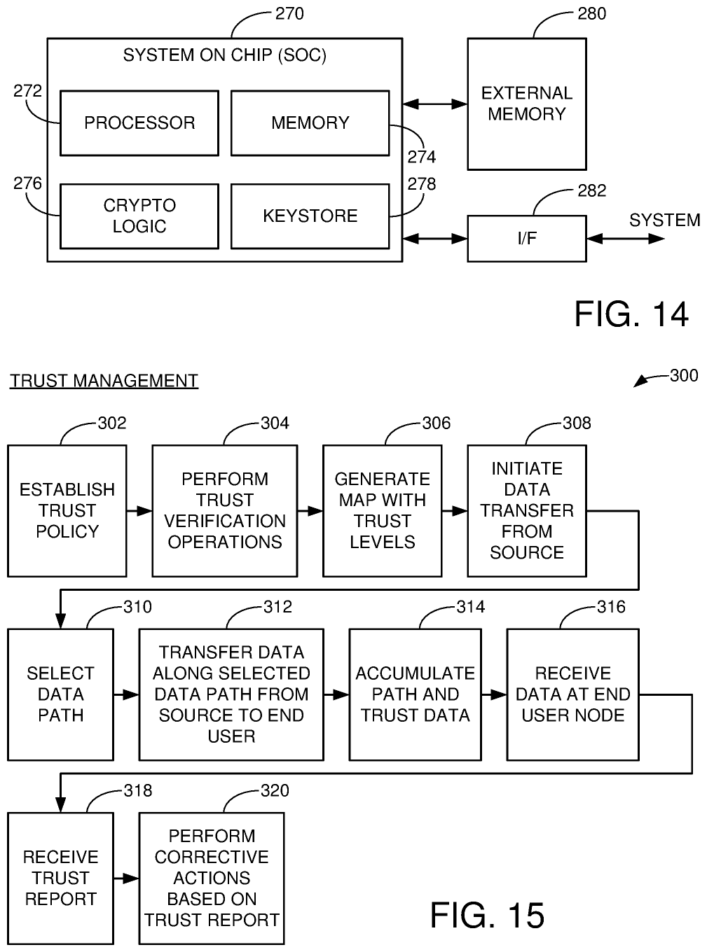

FIG. 14 shows a functional block representation of a storage node 270 in accordance with further embodiments. The storage node 270 includes a system on chip (SOC) device 272 that corresponds to an integrated circuit package with limited external pins to allow access thereto. The SOC 272 includes a programmable processor 274, a :local embedded memory 274, an embedded cryptologic circuit 276 and an embedded kevstore 278.

Generally, as noted above the processor 274 is a programmable processor configured to execute program instructions provided from a local memory, such as the local embedded memory 274. The cryptologic circuit 276 performs a number of different cryptographic based functions, including but not limited to those crypto functions described above in FIGS. 7-9, to protect data coming into and exiting the SOC 270.

The keystore 278 is an embedded hidden memory, whether previously programmable (e.g., ROM, or read-only-memory), write-once memory (such as in the form of OTM or one time programmable memory elements), rewriteable memory, and so on that is used to store hidden data including but not limited to encryption keys and other cryptographic information. The keystore 278 allows cryptographic information, such as embedded encryption keys, to be stored internally within the SOC 270 and processed by internal circuitry such as the cryptologic circuit 276 without providing the ability of an attacking party from accessing signal paths that may access or influence the cryptographic operations being carried out to enhance entropy and trust in accordance with the present discussion.

The SOC 270 can operate in accordance with external memory 280 to temporarily transfer and store data. The external memory 280 can take any number of desired forms including DRAM, flash, etc. An interface (IIF) circuit 272 enables the SOC 270 to communicate with external nodes within the system. These and other mechanisms can he used to enhance trust of a given node.

FIG. 15 provides a functional block representation of a data sequence 300 to represent steps that can be carried out in accordance with the foregoing discussion. It will he understood that these steps are merely illustrative and are not limiting.

At block 302, a trust policy is established. This trust policy can take a number of forms. In some cases, the trust policy can require every node that passes the data be subjected to a highest level of trust. This can include centralized authentication as described above in FIG. 10, so that every node that handles the data is separately authenticated using a known trusted security interface such as the TSI node 222. In other embodiments, the trust policy enacted at block 302 can require at least a minimum level of trust he established for every node passing the data, such as via the peer-to-peer arrangement of FIG. 11 or some other suitable trust arrangement. In still other embodiments, a trust policy can he enacted wherein each node can vouch for at least one other node, so that if a node is trustworthy, that node can assert trustworthiness for one other node. In still other embodiments, the data can passed along any available path, but the policy requires the trust levels be noted for the nodes involved in the transfer.

The granularity of trust utilized in the system can be specified as required. In some cases, a trust policy may allow entropy to be used by various levels of system configurations while not allowing entropy to be used by other levels of system configurations. For example and not by way of limitation, sonic trust policies may allow system hardware resources be used to generate entropy (e.g., as in FIG. 12) but other sources, such as FW and/or OS sources, are not permitted to generate entropy for use in the trust verification and utilization operations.

It will be appreciated that some types of data may be subjected to a first level of trust policy through the network while other types of data may be subjected to a different, second level of trust policy. Regardless, it is contemplated that the actual trust levels of the various nodes involved in any particular transfer will be recorded, allowing the system to take appropriate follow--on actions as required once the data are received at the end user node. It is possible that a given node may have multiple trust “scores” based on different operations involved in verifying that particular node. Stated another way, a particular node may be able to provide data services (e.g., the receipt, processing and/or passage of data sets) with different trust levels depending on different internal configurations.

Continuing with FIG. 15, various trust verification operations may be carried out at block 304 to enhance or otherwise verify various levels of trust for the nodes in the system. This can include the various trust authentication operations described above in FIGS. 12-13, as well as other operations as required. In some cases, a trust policy may require that repeated, continual trust verification operations occur on a regularly scheduled basis in order to maintain the nodes in a known, trusted state. Time/date stamp information and other control data can be accumulated at various times to indicate the latest time at which a particular node was verified.

Block 306 in FIG. 15 shows an operation to generate an up-to-date map of the system with various trust levels. This can provide a real-time indication of the health and trustworthiness of the network at any given time. These elements can be generated, represented and accessed as described above in FIG. 6. The map from block 306 can be used once a data transfer of a selected data set is initiated at block 308, and a suitable data path is selected at block 310.

The selected data set is transferred through the network at block 312. During such transfer, path and trust data are accumulated as indicated at block 314. The transferred data are received at the destination (end user) node at block 316. A trust report is generated and provided coincident with the receipt of the data at block 318. As described above, the trust report includes various types of control data including an indication of the path(s) taken by the data set en route to the destination location, along with information relating to the trust levels of the involved nodes.

As indicated by block 320, various corrective actions are taken as required s a result of the trust report at block 318. This can include additional verification operations, the re-transmittal of data, the calculation of HMAC or other values, and so on as required to verify the data received are trustworthy, irrespective of the trust levels of the source and/or intermediate nodes involved in the data transfer.

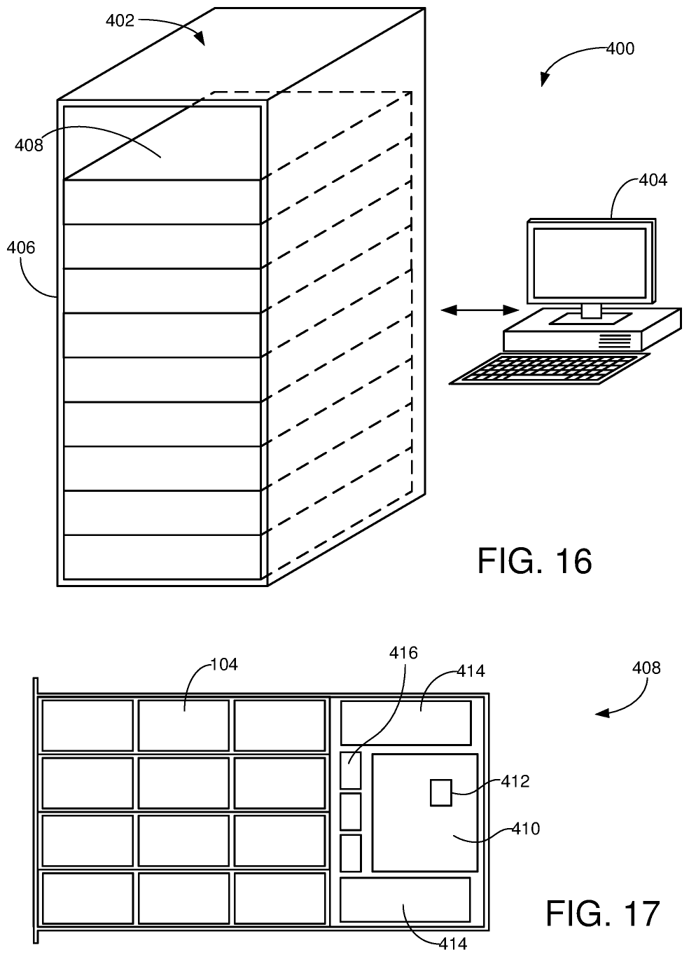

FIG. 16 shows a schematic depiction of a data storage system 400 in which various embodiments of the present disclosure may be advantageously practiced. It will be appreciated that the system 400 can correspond to each of the respective client nodes 112, storage nodes 114, source nodes 122 and 134, and destination (end user) nodes 124 and 136 discussed above. Other aspects of the system can be represented by the data storage system 400 as well.

The data storage system 400 is a mass-data storage system in which a large population of data storage devices such as 104 (FIG. 1) are incorporated into a larger data storage space to provide a storage node as part of a larger geographically distributed network. Examples include a cloud computing environment, a network attached storage (NAS) application, a RAID (redundant array of independent discs) a storage server, a data cluster, an HPC environment, a high performance computing (HPC) system, etc.

The system 400 includes a storage assembly 402 and a computer 404 (e.g., server controller, etc.). The storage assembly 402 may include one or more server cabinets (racks) 406 with a plurality of modular storage enclosures 408. While not limiting, the storage rack 406 is a 42U server cabinet with 42 units (U) of storage, with each unit extending about 1.75 inches (in) of height. The width and length dimensions of the cabinet can vary but common values may be on the order of about 24 in.×36 in. Each storage enclosure 408 can have a height that is a multiple of the storage units, such as 2U (3.5 in.), 3U (5.25 in.), etc. to accommodate a desired number of adjacent storage devices 134. While shown as a separate module, the computer 404 can also be incorporated into the rack 406.

FIG. 17 is a top plan view of a selected storage enclosure 408 that incorporates 36 (3×4×3) data storage devices 104. Other numbers and arrangements of data storage devices can be incorporated into each enclosure, including different types of devices (e.g., HDDs, SDDs, etc.). The storage enclosure 408 includes a number of active elements to support the operation of the various storage devices, such as a controller circuit board 410 with one or more processors 412, power supplies 414 and cooling fans 416.

The modular nature of the various storage enclosures 408 permits removal and installation of each storage enclosure into the storage rack 406 including under conditions where the storage devices 104 in the remaining storage enclosures within the rack are maintained in an operational condition. In some cases, the storage enclosures 408 may be configured with access panels or other features along the outwardly facing surfaces to permit individual storage devices, or groups of devices, to be removed and replaced. Sliding trays, removable carriers and other mechanisms can be utilized to allow authorized agents to access the interior of the storage enclosures as required.

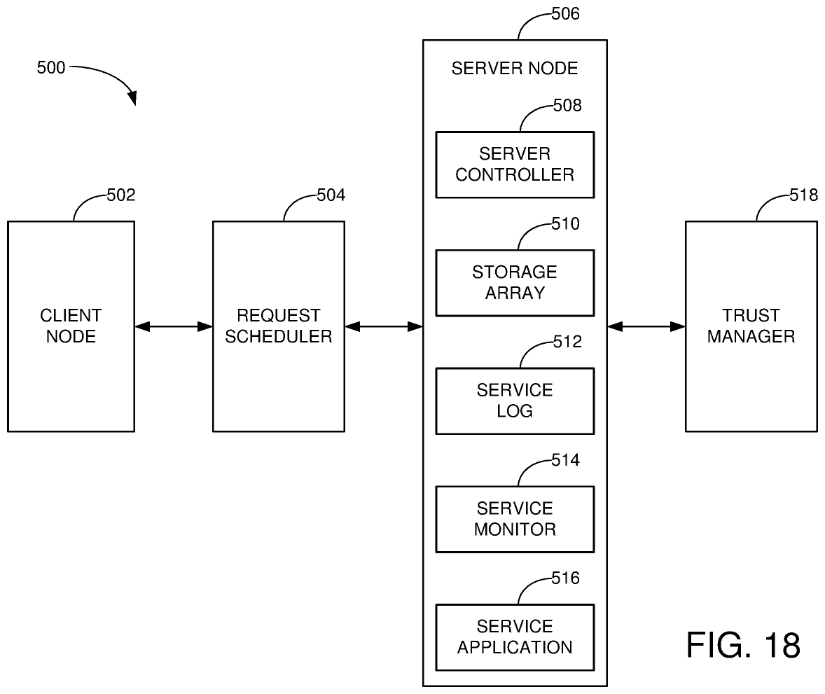

FIG. 18 provides another functional diagram for a data processing system 500 constructed and operated in accordance with various embodiments. The system 500 in FIG. 18 can be readily incorporated into the various systems and networks discussed above.

The system 500 includes a client node 502, which as described above can operate as a user device to initiate a request to carry out an application or other operation in a distributed storage environment of which the system 500 forms a part. The request is forwarded to a request scheduler 502, which operates to manage the request, as well as additional requests, supplied to the system.

A server node 506 represents an application aspect of the overall distributed storage environment, and can include various elements including a server controller 508, a storage array 510, a service log 512, a service monitor 514, and a service application 516. These respective elements can operate as described above to perform operations responsive to the various requests issued to the system as well as to accumulate and process performance metrics associated therewith. The service application 516 can represent data and programming instructions stored in the storage array 510, or elsewhere, that are operated upon as a result of a service request issued by the client node 502 and forwarded to the server node 506 by the request scheduler 504. FIG. 18 further shows a trust manager 518 which operates as described above to establish and monitor trust levels for the server node 506 as well as for other aspects of the system.

It follows that the various mechanisms within the system are well adapted to establish and monitor trust levels for nodes involved in the data transfers carried out from a source node to an end user node. The trust manager configurations disclosed herein provide real-time indications of paths taken through the system as well as up-to-date trust levels of the intermediate nodes. Corrective actions can be taken as required to ensure that the received data meet the requirements of a given specification.

It is to be understood that even though numerous characteristics and advantages of various embodiments of the present disclosure have been set forth in the foregoing description, this description is illustrative only, and changes may be made in detail, especially in matters of structure and arrangements of parts within the principles of the present disclosure to the full extent indicated by the broad general meaning of the terms wherein the appended claims are expressed.

What is claimed is:

1. A method comprising:
assigning a trust level to each of a plurality of nodes in a network, the nodes including a source node and a destination node;
transmitting data, from the source node to the destination node along a selected data path through the network that includes at least one intermediate node in the network operably coupled between the source node and the destination node; and
providing a notification to an end user associated with the transmitted data responsive to a trust level associated with at least a selected one of the source node, the destination node or the at least one intermediate node falling below a predetermined trust level threshold.

2. The method of claim 1, wherein the notification indicates an associated trust level of each of the intermediate nodes within the network between the source node and the end user nodes.

3. The method of claim 1, wherein the assigning step comprises using a centralized trusted interface to establish a trust level for each of the intermediate nodes within the network between the source node and the end user node along which the data are transferred.

4. The method of claim 1, wherein the assigning step comprises using a decentralized, peer-to-peer interface to establish a trust level for each of the intermediate nodes within the network between the source node and the end user node along which the data are transferred.

5. The method of claim 1, further comprising establishing a minimum trust level and directing the data through the network among various ones of the intermediate nodes from the source node to the end user nodes along a path that avoids any selected other ones of the intermediate nodes having an assigned trust level lower than the minimum trust level.

6. The method of claim 1, wherein a trust level is uniquely assigned to each node in the computer network.

7. The method of claim 1, wherein a trust manager operates to record the associated trust levels of each node involved in the transfer of the data from the source node to the end user node and generates the trust report for a user of the destination node.

8. The method of claim 7, wherein corrective actions are taken by the trust manager responsive to the trust report supplied to the user of the destination node.

9. The method of claim 1, wherein the data are arranged as a plurality of packets, wherein at least two of the packets take a different path through the network between the source node and the end user node, and wherein each packet includes a payload of user data and associated control information and trust data that includes path information associated with a path taken through the network and associated trust values of the intermediate nodes along the path.

10. The method of claim 1, wherein trust values are established for each of the intermediate nodes in the network between the source node and the end user node based on at least one encryption key and/or at least one hash function.

11. A computer network, comprising:
a source node configured to transfer a data set;
a destination node configured to receive the data set;
a plurality of intermediate nodes arranged between the source node and the destination node to transfer the data set, along a network path, from the source node to the destination node; and
a trust manager circuit configured to establish an associated trust level for each of the source, destination and intermediate nodes, and to provide a notification to an end user associated with the transmitted data that identifies the associated trust levels of at least the intermediate nodes involved in the transfer of the data set from the source node to the destination node.

12. The apparatus of claim 11 wherein the trust manager circuit identifies, in the notification, whether any of the intermediate nodes have an associated trust level that falls below a predetermined trust level threshold.

13. The apparatus of claim 11, wherein the trust manager circuit comprises a software in a file system used to manage data transfers within the system,

14. The apparatus of claim 11, wherein the trust manager circuit establishes the trust levels of each of the intermediate nodes using a centralized trusted interface that individually communicates security information to each of the intermediate nodes.

15. The apparatus of claim 11, wherein the trust manager circuit establishes the trust levels of each of the intermediate nodes using a decentralized, peer-to-peer interface in which each of a group of the intermediate nodes includes verification information associated with at least one other one of the nodes within the group of the intermediate nodes.

16. The apparatus of claim 11, wherein the trust manager identifies selected ones of the intermediate nodes having an assigned trust level below a selected threshold, and directs the passage of the data set through the network so as to avoid such intermediate nodes with said assigned trust level below the selected threshold.

17. The apparatus of claim 11, wherein the trust manager records the associated trust levels of the intermediate nodes along which the data set is transferred from the source node to the destination node, identifies at least one of said nodes having a trust level below a predetermined threshold, and performs an additional data verification operation upon the data received at the destination node responsive to the data passing through the at least one of said nodes having a trust level below the predetermined threshold.

18. A data storage device comprising:
a controller configured to manage data transfers from a client device;
a non-volatile memory (NVM) arranged to store user data directed from the client device via the controller; and
a trust indication stored in the NVM supplied by a host device to indicate a trustworthiness of the data. storage device during a data exchange between a source node and a destination node in a computer network of which the data storage device forms a part.

19. The data storage device of claim 18. in combination with a trust manager circuit which assigns a tmst value to the data storage device responsive to an indication of trustworthiness of the data storage device based on a hidden set of cryptographic information in Ea keystore of the controller.

20. The data storage device of claim 19. wherein data, exchanges are carried out responsive to inputs supplied from the trust manager circuit via an intervening computer network.
